(19) United States
(12) Patent Application Publication
(10) Pub. No.: US 2026/0227606 A1
(43) Pub. Date: Aug. 6, 2026

(54) OPTICAL SYSTEM AND IMAGE CAPTURING APPARATUS INCLUDING THE SAME

(71) Applicant: CANON KABUSHIKI KAISHA, Tokyo (JP)

(72) Inventor: YUICHI GYODA, Tochigi (JP)

(21) Appl. No.: 19/464,269

(22) Filed: Jan. 29, 2026

(30) Foreign Application Priority Data
Feb. 4, 2025 (JP) 2025-016870

(51) Int. Cl. G02B 13/00; G02B 9/10; G02B 9/12; G02B 9/14; G02B 9/34

(52) U.S. Cl. CPC G02B 13/0065; G02B 9/10; G02B 9/12; G02B 9/14; G02B 9/34; G02B 13/003; G02B 13/0035; G02B 13/004

(57) ABSTRACT

An optical system includes, in order from an object side to an image side, a first lens having positive refractive power, a second lens having negative refractive power disposed adjacent to the first lens on an image side, and a folded optical element disposed adjacent to the second lens on the image side, wherein certain inequalities are satisfied where NdG1 represents a refractive index of a material of the first lens for a d-line, and νdG1 represents an Abbe number of the material of the first lens for the d-line.

### BACKGROUND

### Field of the Technology

The present disclosure relates to an optical system and an image capturing apparatus including the same, and more particularly, to an image capturing optical system suitable for a camera for a mobile terminal including a smartphone, a digital still camera, a video camera, and the like and an image capturing apparatus including the image capturing optical system.

### Description of the Related Art

In recent years, in image capturing optical systems used for image capturing apparatuses such as a camera for a mobile terminal including a smartphone, a digital still camera, and a video camera, there has been a demand for providing high optical performance while being compact.

United States Patent Application Publication No. 2021/0165192 describes a telephoto lens consisting of a positive lens, a folded optical element, and a rear group including four lenses, which are arranged in order from an object side.

### SUMMARY

According to an aspect of the present disclosure, an optical system includes, in order from an object side to an image side, a first lens having positive refractive power, a second lens having negative refractive power disposed adjacent to the first lens on an image side, and a folded optical element disposed adjacent to the second lens on the image side, wherein the following inequalities are satisfied: 1.30<NdG1<1.60; and 73.0<νdG1<120.0, where NdG1 represents a refractive index of a material of the first lens for a d-line, and νdG1 represents an Abbe number of the material of the first lens for the d-line.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view of an optical system according to a first embodiment.

FIG. 2 is an aberration diagram of the optical system according to the first embodiment.

FIG. 3 is a cross-sectional view of an optical system according to a second embodiment.

FIG. 4 is an aberration diagram of the optical system according to the second embodiment.

FIG. 5 is a cross-sectional view of an optical system according to a third embodiment.

FIG. 6 is an aberration diagram of the optical system according to the third embodiment.

FIG. 7 is a cross-sectional view of an optical system according to a fourth embodiment.

FIG. 8 is an aberration diagram of the optical system according to the fourth embodiment.

FIG. 9 is a cross-sectional view of an optical system according to a fifth embodiment.

FIG. 10 is an aberration diagram of the optical system according to the fifth embodiment.

FIG. 11 is a cross-sectional view of an optical system according to a sixth embodiment.

FIG. 12 is an aberration diagram of the optical system according to the sixth embodiment.

FIG. 13 is a cross-sectional view of an optical system according to a seventh embodiment.

FIG. 14 is an aberration diagram of the optical system according to the seventh embodiment.

FIG. 15 is a cross-sectional view of an optical system according to an eighth embodiment.

FIG. 16 is an aberration diagram of the optical system according to the eighth embodiment.

FIG. 17 is a cross-sectional view of an optical system according to a ninth embodiment.

FIG. 18 is an aberration diagram of the optical system according to the ninth embodiment.

FIG. 19 is a cross-sectional view of an optical system according to a tenth embodiment.

FIG. 20 is an aberration diagram of the optical system according to the tenth embodiment.

FIG. 21 is a cross-sectional view of an optical system according to an eleventh embodiment.

FIG. 22 is an aberration diagram of the optical system according to the eleventh embodiment.

FIG. 23 is a cross-sectional view of an optical system according to a twelfth embodiment.

FIG. 24 is an aberration diagram of the optical system according to the twelfth embodiment.

FIGS. 25A, 25B, and 25C are diagrams for explaining an embodiment relating to a folded optical element.

FIG. 26 is a schematic diagram illustrating main components of an image capturing apparatus to which the optical system according to each embodiment is applied.

### DESCRIPTION OF THE EMBODIMENTS

Hereinafter, embodiments disclosed in the present specification will be described in detail with reference to the drawings. In the drawings, the same members are denoted by the same reference numerals, and redundant descriptions are omitted.

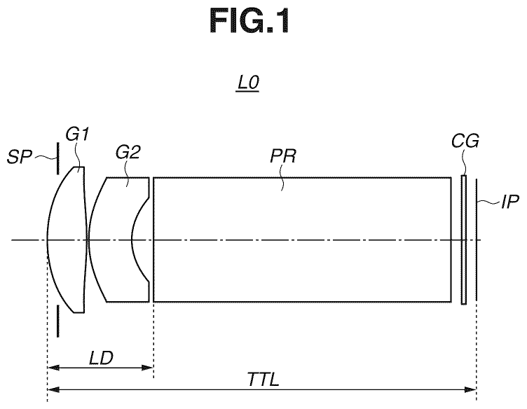

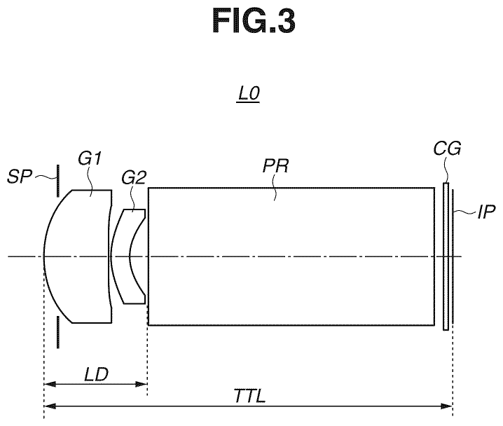

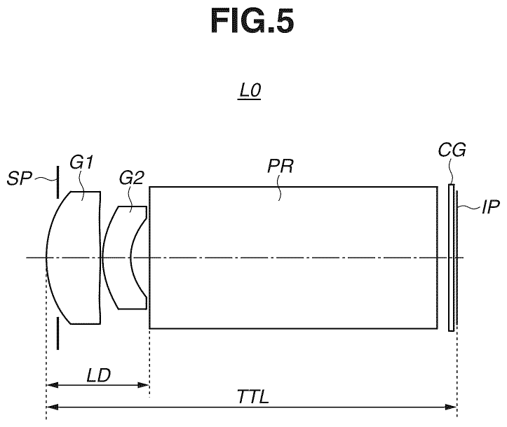

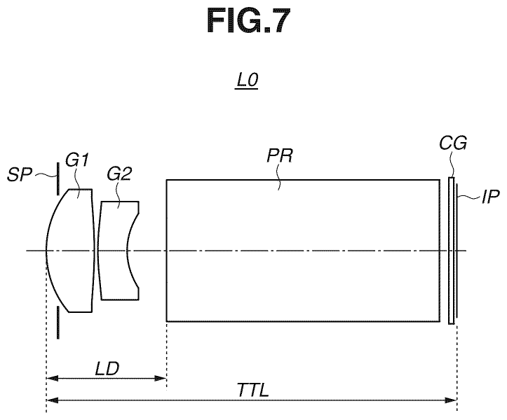

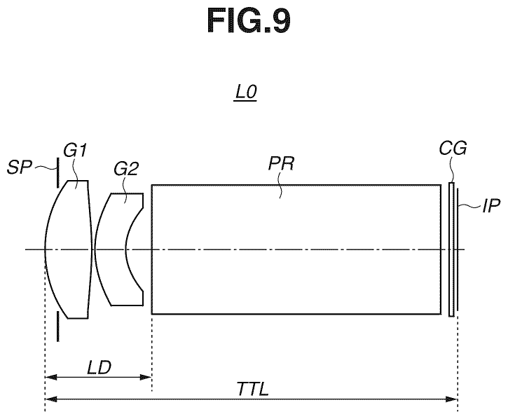

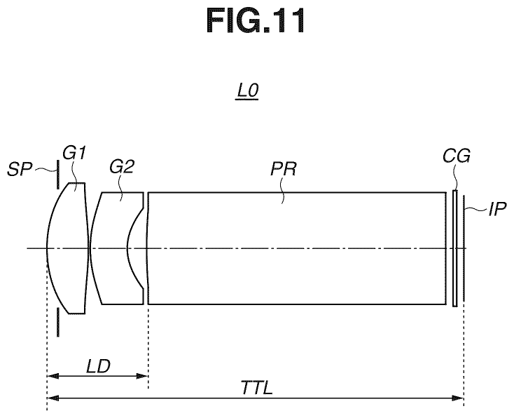

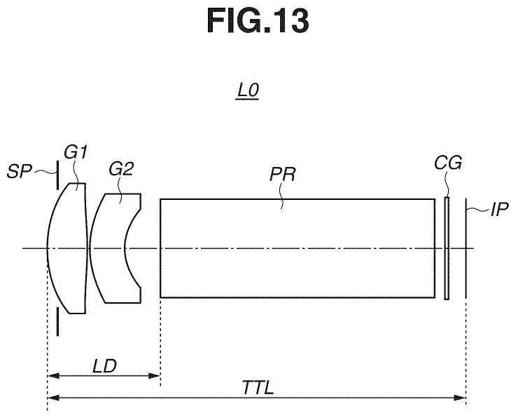

FIGS. 1, 3, 5, 7, 9, 11, 13, 15, 17, 19, 21, and 23 are cross-sectional views of optical systems L0 according to first to twelfth embodiments, respectively. The optical system L0 according to each of the embodiments is used for an image capturing apparatus such as a digital still camera, a digital video camera, a monitoring camera, an in-vehicle camera, and a smartphone.

In each cross-sectional view, the left side corresponds to the object side (front side), and a right side corresponds to the image side (rear side). An aperture stop SP determines (limits) a light flux of the maximum aperture F-number (Fno). The optical system L0 according to each embodiment includes a plurality of lenses or optical elements. Further, the optical system L0 according to each embodiment may include an aspherical lens, a Fresnel lens, a meta-lens, a diffractive optical element, or an optical element having substantially no refractive power such as a cover glass.

When the optical system L0 according to each embodiment is used for an image capturing apparatus such as a camera for a mobile terminal, a video camera, or a digital camera, an image plane IP corresponds to a solid-state image sensor (photoelectric conversion element) such as a charge-coupled device (CCD) sensor or a complementary metal-oxide semiconductor (CMOS) sensor. When the optical system L0 according to each embodiment is used for an image capturing apparatus such as a silver halide film camera, the image plane IP corresponds to a film surface.

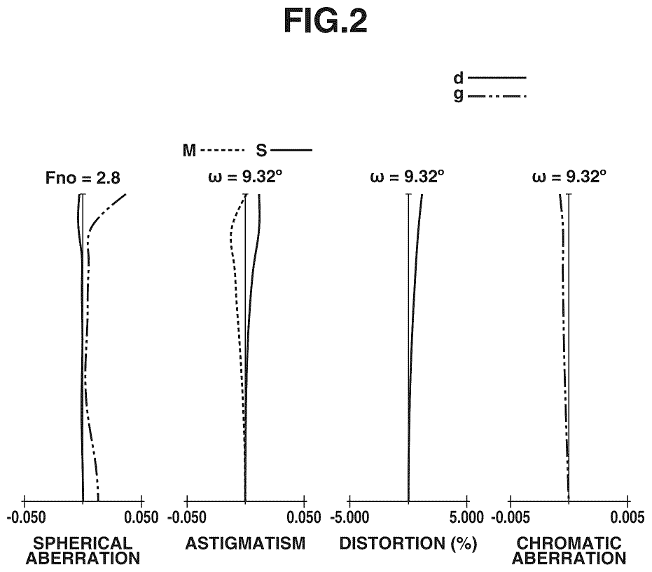

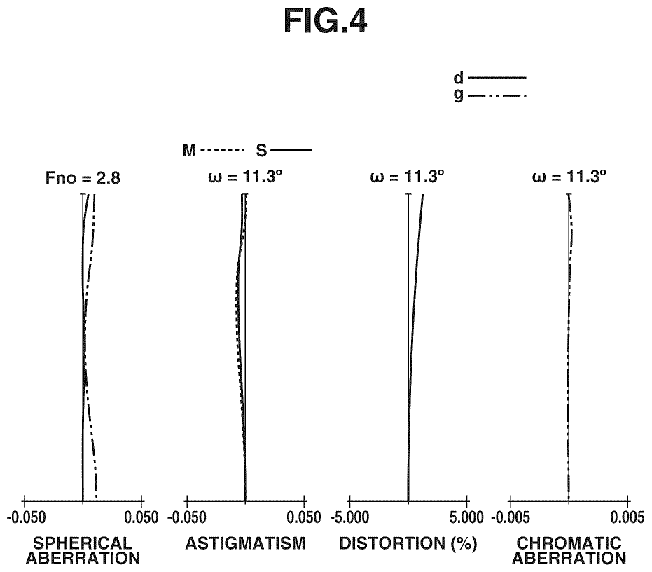

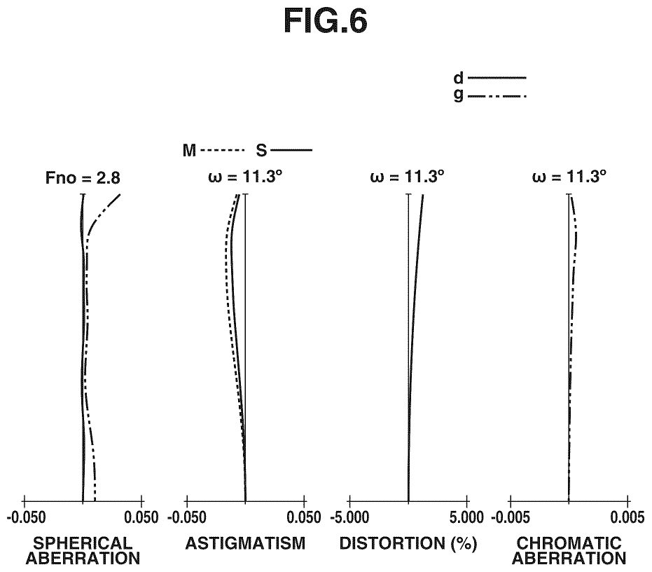

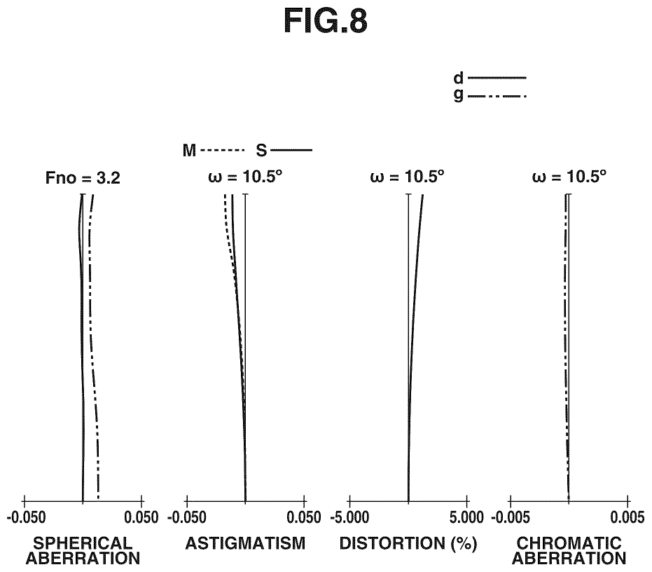

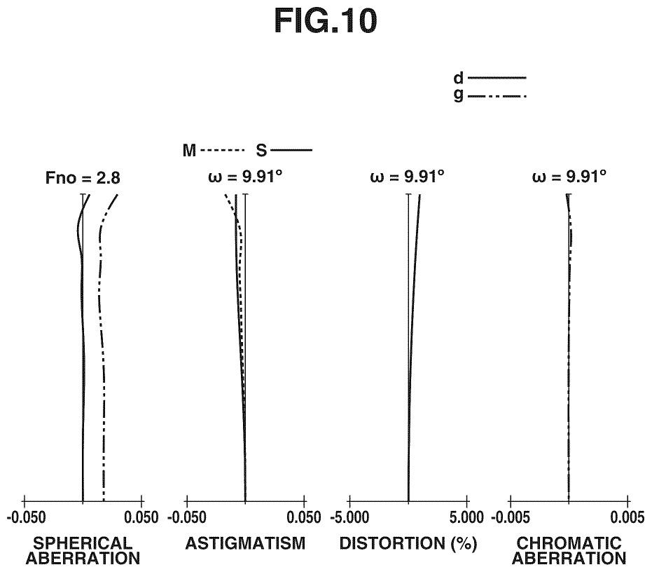

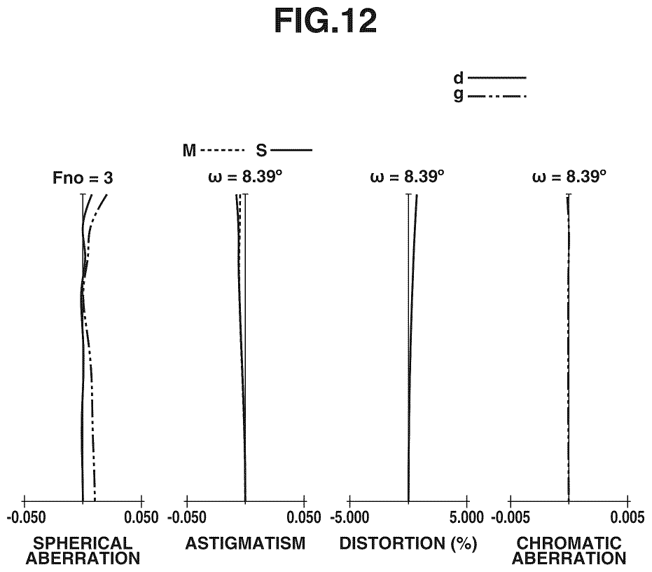

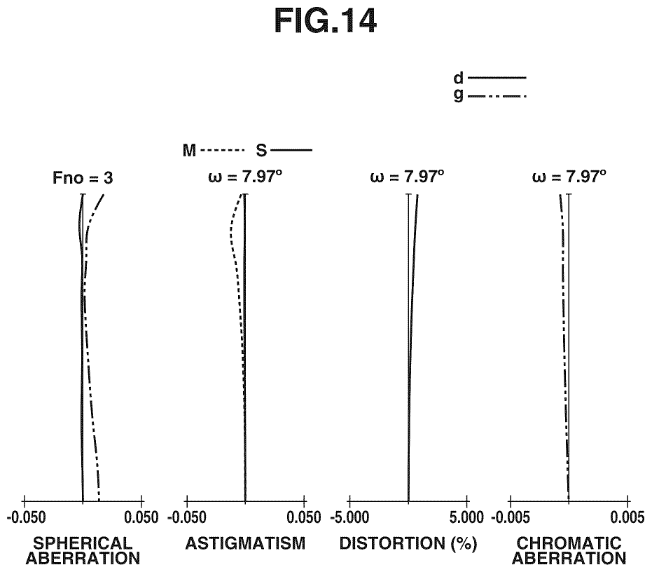

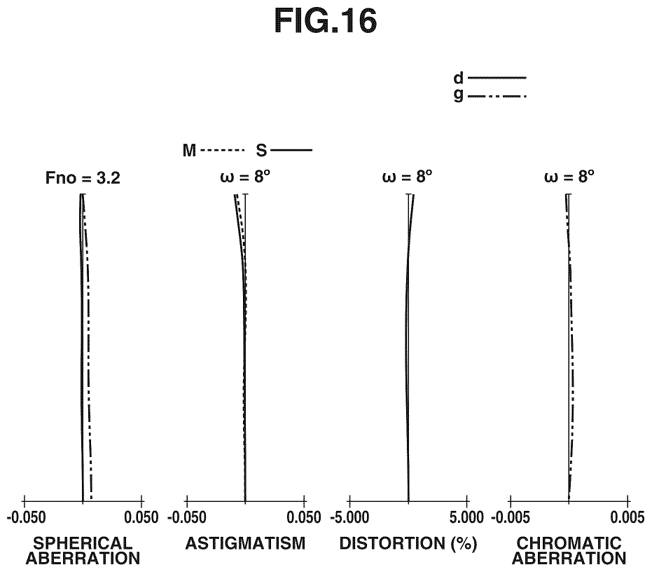

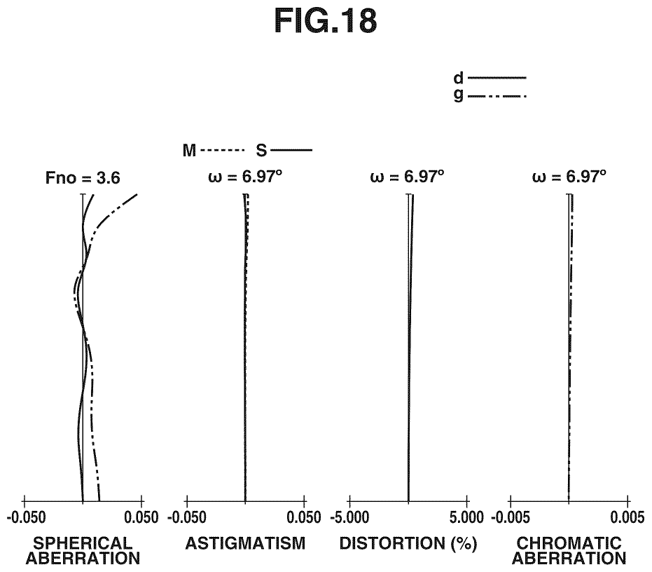

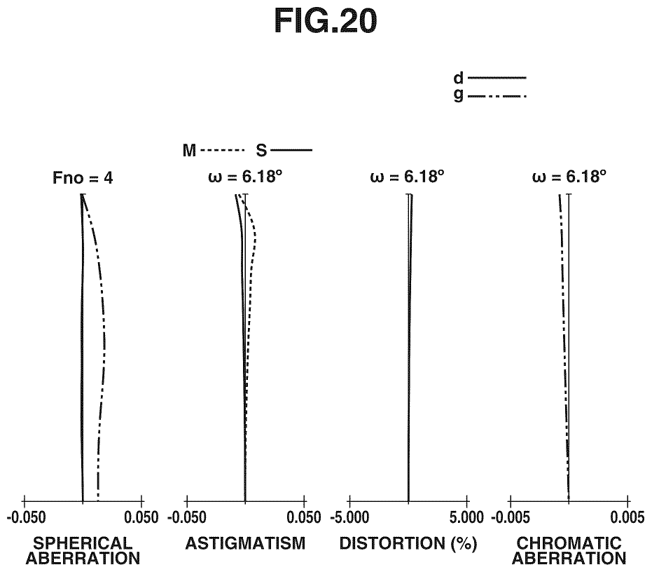

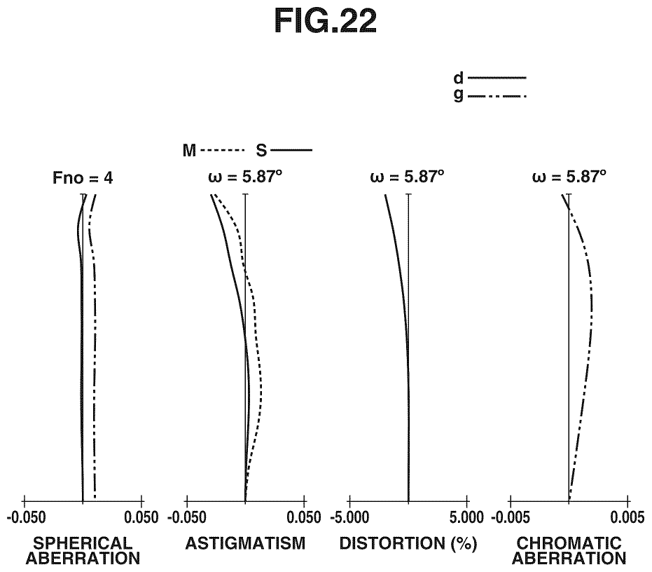

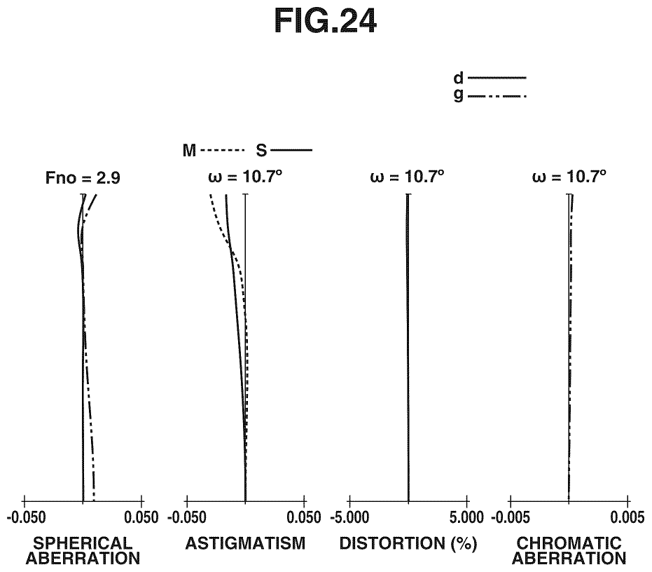

FIGS. 2, 4, 6, 8, 10, 12, 14, 16, 18, 20, 22, and 24 are aberration diagrams of the optical system L0 at infinity focus according to the first to twelfth embodiments, respectively.

In a spherical aberration diagram, Fno represents an F-number. A solid line indicates spherical aberration for a d-line (wavelength of 587.6 nm), while a two-dot chain line indicates spherical aberration for a g-line (wavelength of 435.8 nm). In an astigmatism diagram, a solid line S represents astigmatic aberration of a sagittal image plane, and a broken line M represents an astigmatic aberration of a meridional image plane. In a distortion diagram, a distortion amount for the d-line is illustrated. In a chromatic aberration diagram, a chromatic aberration for the g-line is illustrated, and ω represents a half field angle [°].

Next, a characteristic configuration of the optical system L0 according to each embodiment will be described.

The optical system L0 according to each embodiment includes a first lens G1 that is disposed closest to the object side and has positive refractive power, a second lens G2 that is disposed adjacent to the image side of the first lens G1 and has negative refractive power, and a folded optical element PR that is disposed adjacent to the image side of the second lens G2.

By arranging a positive lens and a negative lens on the object side of the optical system L0, an optical power arrangement becomes a so-called telephoto-type, and since a ray is strongly converged by the first lens G1, the optical system L0 can be made compact. An aberration generated in the positive lens G1 can be corrected by the negative lens G2. The folded optical element PR has a function of bending (refracting) an incident light flux and corresponds to, for example, an optical element such as a prism or a mirror having a reflecting surface.

Next, conditions that can be satisfied by the optical system L0 according to each embodiment will be described.

The optical system L0 according to each embodiment can satisfy one or more of the following conditional expressions (1) to (16).

$$1.3 < NdG 1 < 1.6 \qquad ( 1 )$$

$$65. < vdG 1 < 120. \qquad ( 2 )$$

$$0.2 < \vert fG 1 / fG 2 \vert < 1.2 \qquad ( 3 )$$

$$0.2 < \vert fG 2 / f \vert < 2. \qquad ( 4 )$$

$$0.2 < fG 1 / f < 1. \qquad ( 5 )$$

$$0.01 < tG 1 / f < 0.35 \qquad ( 6 )$$

$$- 2. < ( G 1 R 1 + G 1 R 2 ) / ( G 1 R 1 - G 1 R 2 ) < 0.5 \qquad ( 7 )$$

$$- 3. < ( G 2 R 1 + G 2 R 2 ) / ( G 2 R 1 - G 2 R 2 ) < 7. \qquad ( 8 )$$

$$0.005 < θ gFG 1 - 0.6438 + 0.001682 \times vdG 1 < 0.1 \qquad ( 9 )$$

$$1. < vdG 1 / vdG 2 < 8. \qquad ( 10 )$$

$$0.1 < LD / f < 0.6 \qquad ( 11 )$$

$$0.4 < TTL / f < 4. \qquad ( 12 )$$

$$\vert 1 / ( fG 1 \times vdG 1 ) + 1 / ( fG 2 \times vdG 2 ) \vert < 0.005 \qquad ( 13 )$$

$$4 < ω < 20 \qquad ( 14 )$$

$$0.1 < EA\_IMG / EA\_OBJ < 1. \qquad ( 15 )$$

$$0.2 < LD / fG 1 < 1. \qquad ( 16 )$$

In each of the conditional expressions, various numerical values are represented as follows.

A refractive index of the material of the first lens G1 for the d-line is represented by NdG1, an Abbe number of the material of the first lens G1 for the d-line is represented by νdG1, and an Abbe number of the material of the second lens G2 for the d-line is represented by νdG2.

A focal length of the entire optical system L0 is represented by f, and the total optical length of the optical system L0 is represented by TTL.

A distance on an optical axis from an object-side lens surface of the first lens G1 to an object-side lens surface of the folded optical element PR is represented by LD.

An imaging half field angle corresponding to a maximum image height of the optical system L0 is represented by ω [°].

The focal length of the first lens G1 is represented by fG1, and the focal length of the second lens G2 is represented by fG2.

A radius of curvature of the object-side lens surface of the first lens G1 is represented by G1R1, a radius of curvature of the image-side lens surface of the first lens G1 is represented by G1R2, a radius of curvature of the object-side lens surface of the second lens G2 is represented by G2R1, and a radius of curvature of the image-side lens surface of the second lens G2 is represented by G2R2.

A thickness in an optical axis direction at an optical axis center of the first lens G1 is represented by tG1.

A partial dispersion ratio of the material of the first lens G1 is represented by θgFG1.

An effective aperture diameter of the object-side lens surface of a lens disposed closest to the object side in the optical system L0 is represented by EA_OBJ, and an effective aperture diameter of the image-side lens surface of a lens disposed closest to the image side in the optical system L0 is represented by EA_IMG.

Hereinafter, technical meanings of the conditional expressions described above will be described.

Conditional expression (1) defines the refractive index of the first lens G1 for the d-line. If the value is higher than the upper limit of conditional expression (1), the dispersion of the material of the first lens G1 becomes large, so that the chromatic aberration can be excessively corrected, which is undesirable. If the value is lower than the lower limit of conditional expression (1), the refractive index of the first lens G1 becomes small, so that the radius of curvature of the first lens G1 becomes large, and the optical system L0 becomes large in the optical axis direction, which is undesirable.

The upper limit of conditional expression (1) can be any one of 1.595, 1.590, 1.585, 1.580, 1.575, 1.570, 1.565, 1.560, 1.555, 1.550, 1.545, 1.540, 1.535, and 1.530.

The lower limit of conditional expression (1) can be any one of 1.31, 1.32, 1.33, 1.34, 1.35, 1.36, 1.37, 1.38, 1.39, 1.40, 1.41, 1.42, and 1.43.

Conditional expression (2) defines the Abbe number of the first lens G1 for the d-line. If the value is higher than the upper limit of conditional expression (2), the chromatic aberration can be excessively corrected, which is undesirable. If the value is lower than the lower limit of conditional expression (2), an axial chromatic aberration and a magnification chromatic aberration generated by the first lens G1 become too large, which makes it difficult to favorably correct chromatic aberration throughout the entire optical system L0, which is undesirable.

The upper limit of conditional expression (2) can be any one of 118.0, 116.0, 114.0, 112.0, 110.0, 108.0, 106.0, 104.0, 102.0, 100.0, 98.0, and 96.0.

The lower limit of conditional expression (2) can be any one of 66.0, 66.5, 67.0, 67.5, 68.0, 68.5, 69.0, 69.5, 70.0, 70.5, 71.0, 71.5, 72.0, 72.5, 73.0, 73.5, and 74.0.

Conditional expression (3) defines the ratio between the refractive power of the first lens G1 and the refractive power of the second lens G2. If the value is higher than the upper limit of conditional expression (3), an air space between the first lens G1 and the second lens G2 becomes too large, resulting in an increase in the total length of the optical system L0, which is undesirable. If the value is lower than the lower limit of conditional expression (3), the refractive power of the second lens G2 becomes too weak, making it difficult for the second lens G2 to correct the spherical aberration and axial chromatic aberration generated in the first lens G1, which is undesirable.

Conditional expression (4) defines the refractive power of the second lens G2. If the value is higher than the upper limit of conditional expression (4), the refractive power of the second lens G2 becomes too weak, which makes it difficult for the second lens G2 to correct the spherical aberration and axial chromatic aberration generated by the first lens G1, which is undesirable. If the value is lower than the lower limit of conditional expression (4), the refractive power of the second lens G2 becomes too strong, so that the spherical aberration and astigmatism generated by the first lens G1 can be excessively corrected, which is undesirable.

Conditional expression (5) defines the refractive power of the first lens G1. If the value is higher than the upper limit of conditional expression (5), the refractive power of the first lens G1 becomes too weak, so that the height of a ray incident on the lenses disposed on the image side of the first lens G1 becomes large, which leads to an increase in the diameter of the lenses disposed on the image side of the first lens G1, which is undesirable. If the value is lower than the lower limit of conditional expression (5), the refractive power of the first lens G1 becomes too strong, which results in generation of the strong spherical aberration and coma aberration, which is undesirable.

Conditional expression (6) defines the thickness of the first lens G1 on the optical axis. If the value is higher than the upper limit of conditional expression (6), the thickness of the first lens G1 becomes too large, which leads to an increase in size of the optical system L0 in the optical axis direction, which is undesirable. If the value is lower than the lower limit of conditional expression (6), the thickness of the first lens G1 becomes too small, which leads to an increase in thickness of the folded optical element PR in a radial direction and an increase in size of the optical system L0 in the radial direction, which is undesirable.

Conditional expression (7) defines the shape of the lens surfaces of the first lens G1. If the value is higher than the upper limit of conditional expression (7), the image-side lens surface of the first lens G1 becomes a shape with a strong concave surface facing the object side, resulting in generation of strong coma aberration in the first lens G1, which is undesirable. If the value is lower than the lower limit of conditional expression (7), the first lens G1 becomes a meniscus lens with the strong convex surface facing the object side, resulting in generation of strong spherical aberration in the first lens G1, which is undesirable.

Conditional expression (8) defines the shape of the lens surfaces of the second lens G2. If the value is higher than the upper limit of conditional expression (8), the second lens G2 becomes a meniscus lens with the strong convex surface facing the object side, so that the spherical aberration can be excessively corrected, which is undesirable. If the value is lower than the lower limit of conditional expression (8), the second lens G2 becomes a meniscus lens with the strong concave surface facing the object side, so that rays cannot be converged within the second lens G2, which makes it difficult to reduce the diameter of optical elements of the second lens G2 and subsequent lenses.

Conditional expression (9) defines the partial dispersion ratio of the material of the first lens G1 for the g-line and an F-line. If the value is higher than the upper limit of conditional expression (9), the axial chromatic aberration and magnification chromatic aberration can be excessively corrected, which is undesirable. If the value is lower than the lower limit of conditional expression (9), the axial chromatic aberration and magnification chromatic aberration cannot be sufficiently corrected, which is undesirable.

Conditional expression (10) indicates a condition relating to the ratio between the Abbe number of the first lens G1 and the Abbe number of the second lens G2. If the value is higher than the upper limit of conditional expression (10), the chromatic aberration generated by the second lens G2 can be excessively corrected, which is undesirable. If the value is lower than the lower limit of conditional expression (10), the chromatic aberration generated by the second lens G2 cannot be sufficiently corrected, which is undesirable.

Conditional expression (11) defines the distance on the optical axis from the object-side lens surface of the first lens G1 to an object-side surface of the folded optical element PR. If the value is higher than the upper limit of conditional expression (11), the distance on the optical axis from the first lens G1 to the folded optical element PR increases, which leads to an increase in size of the optical system L0 in the optical axis direction, which is undesirable. If the value is lower than the lower limit of conditional expression (11), the thickness of the first lens G1 and the second lens G2 disposed on the object side of the folded optical element PR decreases, so that the refractive power of the first lens G1 and the second lens G2 becomes too weak, which is undesirable.

Conditional expression (12) defines the ratio between the total optical length of the optical system L0 and the focal length of the entire system. The term “total optical length” used herein refers to the distance on the optical axis from the lens surface closest to the object side to the image plane IP. When an optical element having substantially no refractive power, such as a cover glass, is disposed immediately before the image plane IP, such an optical element is taken into consideration in calculating the total optical length. However, when the optical element having substantially no refractive power, such as a cover glass or a folded optical element, is disposed on the object side of the lens surface closest to the object side, such an optical element is not taken into consideration in calculating the total optical length.

If the value is higher than the upper limit of conditional expression (12), the total optical length of the optical system L0 increases, which leads to an increase in size of the optical system L0 in the optical axis direction, which is undesirable. If the value is lower than the lower limit of conditional expression (12), the refractive power of each of the first lens G1 and the second lens G2 becomes too strong, which makes it difficult to correct various aberrations, which is undesirable.

Conditional expression (13) is what is called an achromatization condition. By satisfying conditional expression (13), the chromatic aberration can be favorably corrected in the optical system L0. If the value is higher than the upper limit of conditional expression (13), it is difficult to correct the axial chromatic aberration and magnification chromatic aberration, which is undesirable.

Conditional expression (14) defines a range of the half field angle corresponding to the maximum image height of the optical system L0. Here, the maximum image height of the optical system L0 indicates a distance from a position where peripheral illumination becomes 10% to the optical axis, when the position on the optical axis on the image plane IP is assumed to have 100% illumination. If the value is higher than the upper limit of conditional expression (14), the height of off-axis rays becomes large, and the diameter of each lens constituting the optical system L0 increases, resulting in an increase in size of the optical system L0 in the radial direction, which is undesirable. If the value is lower than the lower limit of conditional expression (14), the height of a ray incident on the first lens G1 becomes too small, and the total optical length TTL increases, which leads to an increase in size of the optical system L0 in the optical axis direction, which is undesirable.

Conditional expression (15) defines the ratio between the effective aperture diameter of the object-side lens surface of the lens disposed closest to the object side in the optical system L0 and the effective aperture diameter of the image-side lens surface of the lens disposed closest to the image side. The term “lens” used herein refers to a lens having refractive power. The effective diameter of an optical element having substantially no refractive power, such as a cover glass, a mirror, or a prism, is not included in this expression.

If the value is higher than the upper limit of conditional expression (15), the lens diameter of the lens disposed closest to the image side in the optical system L0 increases, leading to an increase in size of the optical system L0 in the radial direction, which is undesirable. If the value is lower than the lower limit of conditional expression (15), the refractive power of the lens disposed closest to the image side in the optical system L0 becomes too strong, making it difficult to correct various aberrations, which is undesirable.

Conditional expression (16) defines the position on the optical axis of the folded optical element PR. If the value is higher than the upper limit of conditional expression (16), the distance on the optical axis between the object-side lens surface of the first lens G1 and the folded optical element PR becomes too large, resulting in an increase in the total length of the optical system L0, which is undesirable.

If the value is lower than the lower limit of conditional expression (16), the distance on the optical axis between the object-side lens surface of the first lens G1 and the folded optical element PR becomes too small, making it difficult to dispose a lens on the object side of the folded optical element PR, which is undesirable.

Numerical ranges of conditional expressions (1) to (16) can be set as in the following conditional expressions (1a) to (16a).

$$1.4 < NdG 1 < 1.57 \qquad ( 1 a )$$

$$73. < vdG 1 < 110. \qquad ( 2 a )$$

$$0.3 < \vert fG 1 / fG 2 \vert < 1.1 \qquad ( 3 a )$$

$$0.3 < \vert fG 2 / f \vert < 1.5 \qquad ( 4 a )$$

$$0.3 < fG 1 / f < 0.8 \qquad ( 5 a )$$

$$0.04 < tG 1 / f < 0.3 \qquad ( 6 a )$$

$$- 1.5 < ( G 1 R 1 + G 1 R 2 ) / ( G 1 R 1 - G 1 R 2 ) < 0.3 \qquad ( 7 a )$$

$$- 2. < ( G 2 R 1 + G 2 R 2 ) / ( G 2 R 1 - G 2 R 2 ) < 6. \qquad ( 8 a )$$

$$0.01 < θ gFG 1 - 0.6438 + 0.001682 \times vdG 1 < 0.08 \qquad ( 9 a )$$

$$1.3 < vdG 1 / vdG 2 < 6. \qquad ( 10 a )$$

$$0.15 < LD / f < 0.5 \qquad ( 11 a )$$

$$0.6 < TTL / f < 3. \qquad ( 12 a )$$

$$\vert 1 / ( fG 1 \times vdG 1 ) + 1 / ( fG 2 \times vdG 2 ) \vert < 0.004 \qquad ( 13 a )$$

$$5 < ω < 17 \qquad ( 14 a )$$

$$0.3 < EA\_IMG / EA\_OBJ < 0.9 \qquad ( 15 a )$$

$$0.3 < LD / fG 1 < 0.85 \qquad ( 16 a )$$

Further, the numerical ranges of conditional expressions (1) to (16) can be set as in the following conditional expressions (1b) to (16b).

$$1.42 < NdG 1 < 1.55 \qquad ( 1 b )$$

$$85. < vdG 1 < 100. \qquad ( 2 b )$$

$$0.6 < \vert fG 1 / fG 2 \vert < 0.9 \qquad ( 3 b )$$

$$0.4 < \vert fG 2 / f \vert < 1. \qquad ( 4 b )$$

$$0.35 < fG 1 / f < 0.7 \qquad ( 5 b )$$

$$0.08 < tG 1 / f < 0.25 \qquad ( 6 b )$$

$$- 1. < ( G 1 R 1 + G 1 R 2 ) / ( G 1 R 1 - G 1 R 2 ) < 0.1 \qquad ( 7 b )$$

$$- 1.6 < ( G 2 R 1 + G 2 R 2 ) / ( G 2 R 1 - G 2 R 2 ) < 5. \qquad ( 8 b )$$

$$0.02 < θ gFG 1 - 0.6438 + 0.001682 \times vdG 1 < 0.05 \qquad ( 9 b )$$

$$1.5 < vdG 1 / vdG 2 < 5. \qquad ( 10 b )$$

$$0.18 < LD / f < 0.4 \qquad ( 11 b )$$

$$0.8 < TTL / f < 2. \qquad ( 12 b )$$

$$\vert 1 / ( fG 1 \times vdG 1 ) + 1 / ( fG 2 \times vdG 2 ) \vert < 0.003 \qquad ( 13 b )$$

$$6 < ω < 15 \qquad ( 14 b )$$

$$0.5 < EA\_IMG / EA\_OBJ < 0.8 \qquad ( 15 b )$$

$$0.4 < LD / fG 1 < 0.75 \qquad ( 16 b )$$

Next, configurations that can be satisfied in the optical system L0 according to each embodiment will be described.

In the optical system L0 according to each embodiment, the folded optical element PR can be disposed adjacent to the second lens G2 on the image side. With this configuration, the height of the on-axis ray that passes through the second lens G2 can be increased, which makes it possible to favorably correct the spherical aberration and axial chromatic aberration.

In the optical system L0 according to each embodiment, at least one of the object-side lens surface and the image-side lens surface of the first lens G1 may have an aspherical shape. By the first lens G1 being an aspherical lens, the spherical aberration and coma aberration generated by the first lens G1 can be reduced. To further enhance the above-described effect, the aspherical shape of at least one of the object-side lens surface and the image-side lens surface of the first lens G1 may be a shape in which positive refractive power becomes weaker toward the periphery from the optical axis center.

Hereinafter, a shape in which refractive power becomes weaker toward the periphery from the optical axis center will be described. This shape refers to a shape in which, when the refractive power at the optical axis center, the refractive power at a point where the image height is 50%, and the refractive power at the periphery are compared, the refractive power at the optical axis center is the strongest, the refractive power at the point where the image height is 50% is weaker than that at the optical axis center, and the refractive power at the periphery is even weaker than that at the point where the image height is 50%. The same holds true for a shape in which the refractive power becomes weaker toward the optical axis center from the periphery.

In the optical system L0 according to each embodiment, at least one of the object-side lens surface and the image-side lens surface of the second lens G2 may have an aspherical shape. By the second lens G2 being an aspherical lens, the spherical aberration, coma aberration, and astigmatism generated by the first lens G1 can be favorably corrected. To enhance the above-described effect, the aspherical shape of at least one of the object-side lens surface and the image-side lens surface of the second lens G2 may be a shape in which negative refractive power becomes stronger toward the periphery from the optical axis center.

In the optical system L0 according to each embodiment, the folded optical element PR can reflect the ray multiple times. By bending (refracting) the ray multiple times, the total length of the optical system L0 can be reduced, and miniaturization of the optical system L0 can be achieved.

In the optical system L0 according to each embodiment, the number of lenses having refractive power among the optical elements included in the optical system L0 can be four or less. By the number of lenses constituting the optical system L0 being reduced, miniaturization of the optical system L0 can be achieved.

Next, optical systems L0 according to the first to twelfth embodiments will be described in detail. Note that descriptions of components of the optical system L0 according to each embodiment that are similar to those of the optical system L0 according to the first embodiment are omitted, and differences between the optical system L0 according to each embodiment and the optical system L0 according to the first embodiment will be described.

### First to Seventh Embodiments

FIGS. 1, 3, 5, 7, 9, 11, and 13 are cross-sectional views illustrating the optical systems L0 according to the first to seventh embodiments, respectively. The optical systems L0 according to the first to seventh embodiments are each composed of the aperture stop SP, the first lens G1 having positive refractive power, the second lens G2 having negative refractive power, and the folded optical element PR, which are arranged in order from the object side.

In the optical system L0 according to the first embodiment, the folded optical element PR is disposed adjacent to the second lens G2 on the image side. With this configuration, the height of the on-axis ray that passes through the second lens G2 can be increased, which makes it possible to favorably correct the spherical aberration and axial chromatic aberration.

In the optical system L0 according to the first embodiment, the image-side lens surface of the first lens G1 has an aspherical shape in which positive refractive power becomes weaker toward the periphery from the optical axis center. The object-side lens surface of the second lens G2 has an aspherical shape in which negative refractive power becomes stronger toward the periphery from the optical axis center.

In the optical system L0 according to the first to seventh embodiments, the second lens G2 is made of a resin material.

### Eighth Embodiment

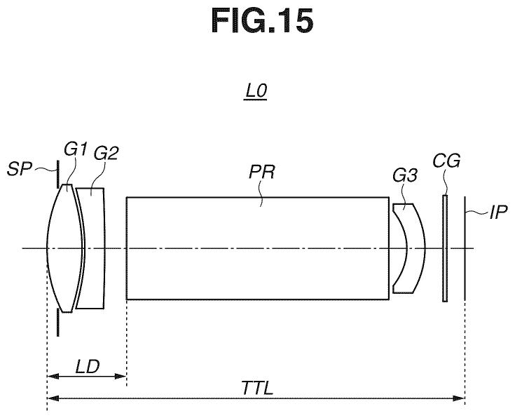

FIG. 15 is a cross-sectional view illustrating the optical system L0 according to an eighth embodiment. The optical system L0 according to the eighth embodiment is composed of the aperture stop SP, the first lens G1 having positive refractive power, the second lens G2 having negative refractive power, the folded optical element PR, and a third lens G3 having negative refractive power, which are arranged in order from the object side. Each of the second lens G2 and the third lens G3 is a meniscus lens with the concave surface facing the image side.

In the optical system L0 according to the eighth embodiment, the third lens G3 having negative refractive power is disposed on the image side of the folded optical element PR. Because the height of the on-axis ray is small and the height of the off-axis ray is large between the folded optical element PR and the image plane IP, by disposing the third lens G3 on the image side of the folded optical element PR, it becomes possible to effectively correct off-axis aberrations such as the astigmatism and coma aberration.

### Ninth and Tenth Embodiments

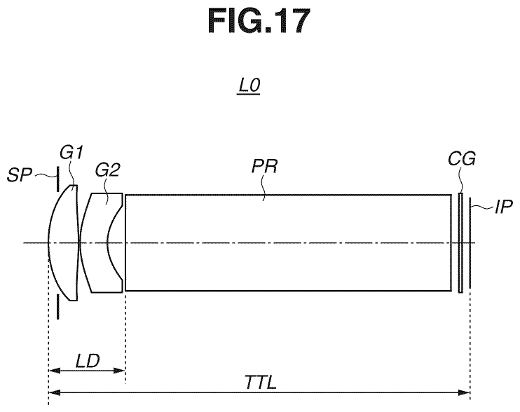

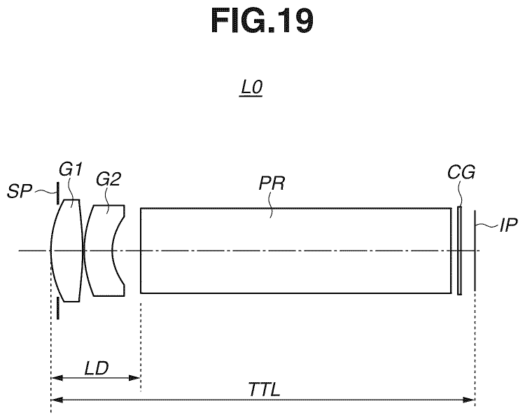

FIGS. 17 and 19 are cross-sectional views illustrating the optical systems L0 according to ninth and tenth embodiments, respectively. The optical systems L0 according to the ninth and tenth embodiments are each composed of the aperture stop SP, the first lens G1 having positive refractive power, the second lens G2 having negative refractive power, and the folded optical element PR, which are arranged in order from the object side.

### Eleventh Embodiment

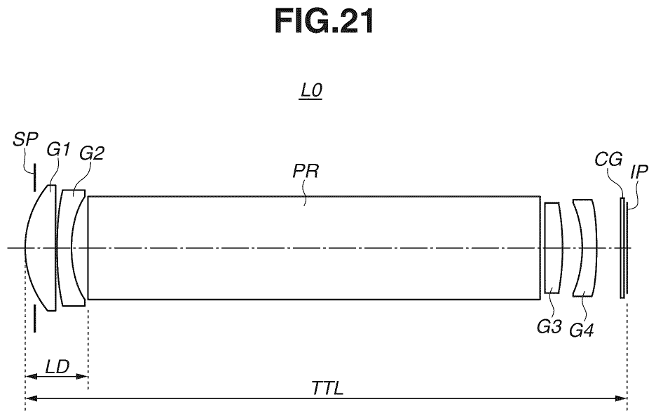

FIG. 21 is a cross-sectional view illustrating lenses of the optical system L0 according to an eleventh embodiment. The optical system L0 according to the eleventh embodiment is composed of the aperture stop SP, the first lens G1 having positive refractive power, the second lens G2 having negative refractive power, the folded optical element PR, the third lens G3 having positive refractive power, and a fourth lens G4 having negative refractive power, which are arranged in order from the object side. Each of the first lens G1 and the second lens G2 is a meniscus lens with the convex surface facing the object side. The fourth lens G4 is a meniscus lens with the convex surface facing the image side.

In the optical system L0 according to the eleventh embodiment, the third lens G3 having positive refractive power and the fourth lens G4 having negative refractive power are disposed on the image side of the folded optical element PR. With this configuration, the chromatic aberration generated on the object side of the folded optical element PR can be favorably corrected.

### Twelfth Embodiment

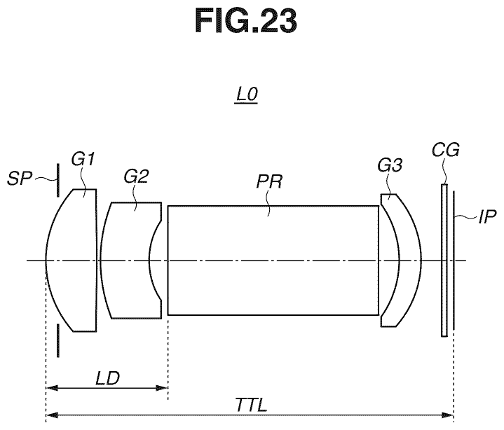

FIG. 23 is a cross-sectional view illustrating lenses of the optical system L0 according to a twelfth embodiment. The optical system L0 according to the twelfth embodiment is composed of the aperture stop SP, the first lens G1 having positive refractive power, the second lens G2 having negative refractive power, the folded optical element PR, and the third lens G3 having negative refractive power, which are arranged in order from the object side. The second lens G2 is a meniscus lens with the convex surface facing the object side. The third lens G3 is a meniscus lens with the convex surface facing the image side.

Hereinafter, first to twelfth numerical examples corresponding to the first to twelfth embodiments, respectively, will be described. In each numerical example, a surface number “i” indicates the order of a surface counted from the object side. “r” represents a radius of curvature (mm) of the i-th surface from the object side, “d” represents a lens thickness or an air space (mm) on the optical axis between the i-th surface and an (i+1)-th surface, and “nd” represents a refractive index for the d-line of an optical material between the i-th surface and the (i+1)-th surface. The sign of “d” is defined such that a direction from the object side toward the image side on the optical axis is positive. “νd” represents the Abbe number of the optical material between the i-th surface and the (i+1)-th surface based on the d-line. “θgF” represents a partial dispersion ratio of the optical material between the i-th surface and the (i+1)-th surface.

“BF” represents a back focus (mm). A total lens length refers to a distance on the optical axis from the lens surface closest to the object side (frontmost surface) of the optical system L0 to the image plane IP.

When the optical surface is aspherical, a sign (*) is attached to the right side of the surface number. The aspherical shape is represented by the following equation:

$$X = ( {h}^{2} / R ) {/ [ 1 + \{ 1 - ( 1 + k ) {( h / R )}^{2} \} ]}^{1 / 2} + A 4 \times {h}^{4} + A 6 \times {h}^{6} + A 8 \times {h}^{8} + A 10 \times {h}^{10} + A 12 \times {h}^{12}$$

where X denotes the displacement from the surface vertex in the optical axis direction, h denotes the height from the optical axis in the direction perpendicular to the optical axis, R denotes the paraxial radius of curvature, k denotes the conic constant, and A4, A6, A8, A10, and A12 denote the aspherical coefficients of respective orders. “e±XX” in each aspherical coefficient means “×10±^{XX}”.

[First Numerical Example]
Unit: mm
Surface Data

| Surface | | | | | Effective | |
|---|---|---|---|---|---|---|
| Number | r | d | nd | νd | Diameter | θ gF |
| 1 (aperture) | ∞ | −0.50 | 6.07 | | | |
| 2* | 5.870 | 1.85 | 1.43875 | 94.7 | 6.07 | 0.5340 |
| 3* | −14.785 | 0.10 | 5.72 | | | |
| 4* | 4.831 | 2.02 | 1.63910 | 23.5 | 5.13 | |
| 5* | 2.474 | 1.03 | 3.58 | | | |
| 6 | ∞ | 13.98 | 1.65844 | 50.9 | 3.44 | |
| 7 | ∞ | 0.50 | 5.11 | | | |
| 8 | ∞ | 0.20 | 1.51633 | 64.1 | 5.35 | |
| 9 | ∞ | 0.50 | 5.41 | | | |
| Image Plane | ∞ | | | | | |

Aspherical Data

| | | |
|---|---|---|
| 2nd Surface | | |
| K = 0.00000e+00 | A4 = 3.30004e−04 | A6 = 6.42380e−05 |
| A8 = −1.37369e−05 | A10 = 2.08085e−06 | A12 = −6.91236e−08 |
| 3rd Surface | | |
| K = −6.08989e+01 | A4 = 8.89556e−04 | A6 = −1.75828e−04 |
| A8 = 3.77661e−05 | A10 = −1.85352e−06 | |
| 4th Surface | | |
| K = −6.42070e+00 | A4 = 6.69319e−03 | A6 = −9.58072e−04 |
| A8 = 1.19506e−04 | A10 = −7.22552e−06 | |
| 5th Surface | | |
| K = −3.84056e+00 | A4 = 2.39761e−02 | A6 = −4.81833e−03 |
| A8 = 1.06617e−03 | A10 = −1.36782e−04 | A12 = 5.79097e−06 |

| | |
|---|---|
| Focal Length | 17.00 |
| F-number | 2.80 |
| Half Field Angle | 9.32 |
| Image Height | 2.82 |
| BF | 0.50 |

Single Lens Data

| Lens | Start Surface | Focal Length |
|---|---|---|
| G1 | 1 | 9.85 |
| G2 | 4 | −11.91 |
| PR | 6 | INF |
| CG | 8 | INF |

[Second Numerical Example]
Unit: mm
Surface Data

| Surface | | | | | Effective | |
|---|---|---|---|---|---|---|
| Number | r | d | nd | νd | Diameter | θ gF |
| 1 (aperture) | ∞ | −0.60 | 5.00 | | | |
| 2* | 4.251 | 2.75 | 1.49700 | 81.5 | 5.00 | 0.5375 |
| 3* | −54.791 | 0.10 | 3.93 | | | |
| 4* | 3.033 | 0.80 | 1.63560 | 23.9 | 3.62 | |
| 5* | 1.877 | 0.75 | 2.99 | | | |
| 6 | ∞ | 12.21 | 1.65160 | 58.5 | 2.92 | |
| 7 | ∞ | 0.40 | 5.26 | | | |
| 8 | ∞ | 0.20 | 1.51633 | 64.1 | 5.47 | |
| 9 | ∞ | 0.19 | 5.54 | | | |
| Image Plane | ∞ | | | | | |

Aspherical Data

| | | |
|---|---|---|
| 2nd Surface | | |
| K = 0.00000e+00 | A4 = 1.11248e−03 | A6 = 7.02492e−05 |
| A8 = 6.84590e−06 | A10 = −8.63334e−07 | A12 = 1.90133e−07 |
| 3rd Surface | | |
| K = 5.30315e+02 | A4 = 1.13577e−02 | A6 = −2.22221e−03 |
| A8 = 5.19972e−04 | A10 = −6.03013e−05 | A12 = 4.59793e−06 |
| 4th Surface | | |
| K = 5.06962e−01 | A4 = −1.02850e−02 | A6 = −1.04365e−03 |
| A8 = −4.35171e−04 | A10 = 1.32647e−04 | A12 = −1.68454e−05 |
| 5th Surface | | |
| K = −2.64086e−01 | A4 = −2.51170e−02 | A6 = 1.55978e−03 |
| A8 = −2.18016e−03 | A10 = 6.24108e−04 | A12 = −9.34248e−0 |

| | |
|---|---|
| Focal Length | 14.00 |
| F-number | 2.80 |
| Half Field Angle | 11.30 |
| Image Height | 2.82 |
| BF | 0.19 |

Single Lens Data

| Lens | Start Surface | Focal Length |
|---|---|---|
| G1 | 1 | 8.06 |
| G2 | 4 | −10.57 |
| PR | 6 | INF |
| CG | 8 | INF |

[Third Numerical Example]
Unit: mm
Surface Data

| Surface | | | | | Effective | |
|---|---|---|---|---|---|---|
| Number | r | d | nd | νd | Diameter | θ gF |
| 1 (aperture) | ∞ | −0.50 | 5.00 | | | |
| 2* | 4.723 | 2.30 | 1.43875 | 94.7 | 5.00 | 0.5340 |
| 3* | −18.508 | 0.10 | 4.35 | | | |
| 4* | 3.433 | 1.19 | 1.66080 | 20.4 | 3.95 | |
| 5* | 2.090 | 0.81 | 3.04 | | | |
| 6 | ∞ | 12.25 | 1.63854 | 55.4 | 2.95 | |
| 7 | ∞ | 0.50 | 5.27 | | | |
| 8 | ∞ | 0.21 | 1.51633 | 64.1 | 5.53 | |
| 9 | ∞ | 0.09 | 5.60 | | | |
| Image Plane | ∞ | | | | | |

Aspherical Data

| | | |
|---|---|---|
| 2nd Surface | | |
| K = 0.00000e+00 | A4 = 9.11421e−04 | A6 = 9.91468e−07 |
| A8 = 1.47543e−05 | | |
| 3rd Surface | | |
| K = −3.01768e+02 | A4 = 1.17873e−03 | A6 = 3.42684e−05 |
| A8 = 1.56119e−04 | A10 = −3.22530e−05 | A12 = 1.99947e−06 |
| 4th Surface | | |
| K = 8.18586e−01 | A4 = −4.65330e−03 | A6 = −1.42716e−03 |
| A8 = 3.18814e−04 | A10 = −5.39709e−05 | A12 = −9.49667e−07 |
| 5th Surface | | |
| K = 9.81593e−02 | A4 = −1.60037e−02 | A6 = −6.15574e−04 |
| A8 = 1.06363e−03 | A10 = 3.82515e−04 | A12 = −1.15335e−04 |

| | |
|---|---|
| Focal Length | 14.00 |
| F-number | 2.80 |
| Half Field Angle | 11.30 |
| Image Height | 2.82 |
| BF | 0.09 |

Single Lens Data

| Lens | Start Surface | Focal Length |
|---|---|---|
| G1 | 1 | 8.84 |
| G2 | 4 | −12.49 |
| PR | 6 | INF |
| CG | 8 | INF |

[Fourth Numerical Example]
Unit: mm
Surface Data

| Surface | | | | | Effective | |
|---|---|---|---|---|---|---|
| Number | r | d | nd | νd | Diameter | θ gF |
| 1 (aperture) | ∞ | −0.50 | 4.69 | | | |
| 2* | 4.085 | 2.05 | 1.52841 | 76.5 | 4.69 | 0.5396 |
| 3* | −15.343 | 0.15 | 4.12 | | | |
| 4* | 9.148 | 1.24 | 1.56650 | 37.6 | 3.78 | |
| 5* | 2.566 | 1.69 | 2.89 | | | |
| 6 | ∞ | 11.64 | 1.60300 | 65.4 | 2.48 | |
| 7 | ∞ | 0.40 | 5.34 | | | |
| 8 | ∞ | 0.21 | 1.51633 | 64.1 | 5.54 | |
| 9 | ∞ | 0.09 | 5.60 | | | |
| Image Plane | ∞ | | | | | |

Aspherical Data

| | | |
|---|---|---|
| 2nd Surface | | |
| K = 0.00000e+00 | A4 = 2.87618e−04 | A6 = 2.64324e−05 |
| 3rd Surface | | |
| K = 0.00000e+00 | A4 = 4.15562e−03 | A6 = −6.58862e−04 |
| A8 = 5.91405e−05 | A10 = −1.63513e−06 | |
| 4th Surface | | |
| K = 0.00000e+00 | A4 = −3.96086e−03 | A6 = −1.74374e−04 |
| A8 = −2.42116e−05 | A10 = 8.85696e−06 | |
| 5th Surface | | |
| K = 0.00000e+00 | A4 = −1.07159e−02 | A6 = 1.78619e−04 |
| A8 = 2.73718e−04 | A10 = −1.71863e−04 | A12 = 3.98614e−05 |

| | |
|---|---|
| Focal Length | 15.00 |
| F-number | 3.20 |
| Half Field Angle | 10.50 |
| Image Height | 2.82 |
| BF | 0.09 |

Single Lens Data

| Lens | Start Surface | Focal Length |
|---|---|---|
| G1 | 1 | 6.34 |
| G2 | 4 | −6.76 |
| PR | 6 | INF |
| CG | 8 | INF |

[Fifth Numerical Example]
Unit: mm
Surface Data

| Surface | | | | | Effective | |
|---|---|---|---|---|---|---|
| Number | r | d | nd | νd | Diameter | θ gF |
| 1 (aperture) | ∞ | −0.60 | 5.71 | | | |
| 2* | 5.460 | 2.19 | 1.43875 | 94.7 | 5.71 | 0.5340 |
| 3* | −13.929 | 0.15 | 5.26 | | | |
| 4* | 4.227 | 1.44 | 1.61550 | 25.8 | 4.67 | |
| 5* | 2.352 | 1.22 | 3.53 | | | |
| 6 | ∞ | 13.52 | 1.58913 | 61.1 | 3.33 | |
| 7 | ∞ | 0.40 | 5.41 | | | |
| 8 | ∞ | 0.21 | 1.51633 | 64.1 | 5.54 | |
| 9 | ∞ | 0.19 | 5.59 | | | |
| Image Plane | ∞ | | | | | |

Aspherical Data

| | | |
|---|---|---|
| 2nd Surface | | |
| K = 0.00000e+00 | A4 = 1.71111e−04 | A6 = 9.35402e−06 |
| 3rd Surface | | |
| K = 0.00000e+00 | A4 = 2.65689e−03 | A6 = −1.41947e−04 |
| A8 = 2.87984e−06 | A10 = 8.76811e−08 | |
| 4th Surface | | |
| K = 0.00000e+00 | A4 = −2.54353e−03 | A6 = 7.06858e−05 |
| A8 = −2.82017e−05 | A10 = 1.15178e−06 | |
| 5th Surface | | |
| K = 0.00000e+00 | A4 = −1.09346e−02 | A6 = 1.27725e−05 |
| A8 = −3.58757e−04 | A10 = 6.10638e−05 | A12 = −1.23936e−05 |

| | |
|---|---|
| Focal Length | 16.00 |
| F-number | 2.80 |
| Half Field Angle | 9.91 |
| Image Height | 2.82 |
| BF | 0.19 |

Single Lens Data

| Lens | Start Surface | Focal Length |
|---|---|---|
| G1 | 1 | 9.26 |
| G2 | 4 | −12.19 |
| PR | 6 | INF |
| CG | 8 | INF |

[Sixth Numerical Example]
Unit: mm
Surface Data

| Surface | | | | | Effective | |
|---|---|---|---|---|---|---|
| Number | r | d | nd | νd | Diameter | θ gF |
| 1 (aperture) | ∞ | −0.60 | 6.33 | | | |
| 2* | 6.311 | 2.25 | 1.43875 | 94.7 | 6.33 | 0.5340 |
| 3* | −12.398 | 0.10 | 5.87 | | | |
| 4* | 5.951 | 2.00 | 1.56650 | 37.6 | 5.35 | |
| 5* | 2.534 | 1.05 | 3.93 | | | |
| 6 | 27.229 | 16.19 | 1.53775 | 74.7 | 3.83 | |
| 7 | ∞ | 0.40 | 5.29 | | | |
| 8 | ∞ | 0.20 | 1.51633 | 64.1 | 5.44 | |
| 9 | ∞ | 0.39 | 5.49 | | | |
| Image Plane | ∞ | | | | | |

Aspherical Data

| | | |
|---|---|---|
| 2nd Surface | | |
| K = 0.00000e+00 | A4 = 4.11004e−04 | A6 = 1.27786e−05 |
| A8 = 1.39264e−06 | A10 = 1.49820e−08 | A12 = −1.22904e−10 |
| 3rd Surface | | |
| K = 0.00000e+00 | A4 = 3.17495e−03 | A6 = −1.50209e−04 |
| A8 = 6.90799e−06 | A10 = −2.02560e−07 | |
| 4th Surface | | |
| K = 0.00000e+00 | A4 = −1.94256e−03 | A6 = 6.96454e−05 |
| A8 = −1.37314e−05 | A10 = 2.41456e−07 | |
| 5th Surface | | |
| K = 0.00000e+00 | A4 = −1.19251e−02 | A6 = 1.09786e−04 |
| A8 = −2.21864e−04 | A10 = 3.18356e−05 | A12 = −5.87070e−06 |

| | |
|---|---|
| Focal Length | 19.00 |
| F-number | 3.00 |
| Half Field Angle | 8.39 |
| Image Height | 2.82 |
| BF | 0.39 |

Single Lens Data

| Lens | Start Surface | Focal Length |
|---|---|---|
| G1 | 1 | 9.89 |
| G2 | 4 | −9.88 |
| PR | 6 | 50.64 |
| CG | 8 | INF |

[Seventh Numerical Example]
Unit: mm
Surface Data

| Surface | | | | | Effective | |
|---|---|---|---|---|---|---|
| Number | r | d | nd | νd | Diameter | θ gF |
| 1 (aperture) | ∞ | −0.60 | 6.67 | | | |
| 2* | 6.532 | 2.30 | 1.43875 | 94.7 | 6.67 | 0.5340 |
| 3* | −18.826 | 0.15 | 6.18 | | | |
| 4* | 5.319 | 2.00 | 1.61550 | 25.8 | 5.58 | |
| 5* | 2.839 | 2.05 | 4.08 | | | |
| 6 | ∞ | 15.75 | 1.72916 | 54.7 | 3.64 | |
| 7 | ∞ | 0.60 | 4.99 | | | |
| 8 | ∞ | 0.20 | 1.51633 | 64.1 | 5.21 | |
| 9 | ∞ | 1.00 | 5.26 | | | |
| Image Plane | ∞ | | | | | |

Aspherical Data

| | | |
|---|---|---|
| 2nd Surface | | |
| K = 0.00000e+00 | A4 = 1.89452e−04 | A6 = 2.39549e−05 |
| A8 = −2.24014e−06 | A10 = 2.61763e−07 | A12 = −5.09180e−09 |
| 3rd Surface | | |
| K = 0.00000e+00 | A4 = 1.86929e−03 | A6 = −1.14865e−04 |
| A8 = 9.97503e−06 | A10 = −3.01784e−07 | |
| 4th Surface | | |
| K = 0.00000e+00 | A4 = −7.16550e−04 | A6 = −8.77777e−05 |
| A8 = 1.00089e−05 | A10 = −7.42266e−07 | |
| 5th Surface | | |
| K = 0.00000e+00 | A4 = −5.34171e−03 | A6 = −2.81702e−04 |
| A8 = 2.01495e−05 | A10 = −1.08858e−05 | A12 = −3.16069e−08 |

| | |
|---|---|
| Focal Length | 20.00 |
| F-number | 3.00 |
| Half Field Angle | 7.97 |
| Image Height | 2.82 |
| BF | 1.00 |

Single Lens Data

| Lens | Start Surface | Focal Length |
|---|---|---|
| G1 | 1 | 11.37 |
| G2 | 4 | −14.28 |
| PR | 6 | INF |
| CG | 8 | INF |

[Eighth Numerical Example]
Unit: mm
Surface Data

| Surface | | | | | Effective | |
|---|---|---|---|---|---|---|
| Number | r | d | nd | νd | Diameter | θ gF |
| 1 (aperture) | ∞ | −0.60 | 6.25 | | | |
| 2 | 7.591 | 1.94 | 1.43875 | 94.7 | 6.25 | 0.5340 |
| 3* | −8.723 | 0.15 | 6.03 | | | |
| 4* | −10.065 | 1.10 | 1.53160 | 55.8 | 5.89 | |
| 5* | −73.130 | 1.21 | 5.55 | | | |
| 6 | ∞ | 14.50 | 1.51742 | 52.4 | 5.03 | |
| 7 | ∞ | 1.00 | 3.63 | | | |
| 8* | −3.043 | 1.00 | 1.61550 | 25.8 | 3.73 | |
| 9 | −4.845 | 1.00 | 4.44 | | | |
| 10 | ∞ | 0.21 | 1.51633 | 64.1 | 5.14 | |
| 11 | ∞ | 1.00 | 5.20 | | | |
| Image Plane | ∞ | | | | | |

Aspherical Data

| | | |
|---|---|---|
| 3rd Surface | | |
| K = 0.00000e+00 | A4 = 1.00118e−03 | A6 = −6.15049e−05 |
| A8 = 7.04917e−06 | A10 = −2.31715e−07 | |
| 4th Surface | | |
| K = 0.00000e+00 | A4 = 3.83009e−04 | A6 = −3.36829e−05 |
| A8 = 6.63844e−06 | A10 = −1.81243e−07 | A12 = −3.59197e−09 |
| 5th Surface | | |
| K = 0.00000e+00 | A4 = −2.33599e−04 | A6 = 2.08784e−05 |
| A8 = 4.07068e−07 | A10 = 6.07351e−08 | A12 = −5.48356e−09 |
| 8th Surface | | |
| K = 0.00000e+00 | A4 = −1.17038e−03 | A6 = 1.10232e−03 |
| A8 = −1.63760e−04 | A10 = 3.53382e−05 | A12 = −2.44381e−06 |
| 9th Surface | | |
| K = 0.00000e+00 | A4 = −3.7048le−03 | A6 = 9.02249e−04 |
| A8 = −1.41582e−04 | A10 = 1.81904e−05 | A12 = −9.81065e−07 |

| | |
|---|---|
| Focal Length | 20.00 |
| F-number | 3.20 |
| Half Field Angle | 8.00 |
| Image Height | 2.82 |
| BF | 1.00 |

Single Lens Data

| Lens | Start Surface | Focal Length |
|---|---|---|
| G1 | 1 | 9.60 |
| G2 | 4 | −22.09 |
| PR | 6 | INF |
| G3 | 8 | −16.86 |
| CG | 10 | INF |

[Ninth Numerical Example]
Unit: mm
Surface Data

| Surface | | | | | Effective | |
|---|---|---|---|---|---|---|
| Number | r | d | nd | νd | Diameter | θ gF |
| 1 (aperture) | ∞ | −0.60 | 6.39 | | | |
| 2* | 6.358 | 1.90 | 1.43875 | 94.9 | 6.39 | 0.5340 |
| 3* | −15.198 | 0.10 | 6.02 | | | |
| 4* | 5.507 | 1.72 | 1.56650 | 37.6 | 5.49 | |
| 5* | 2.724 | 1.08 | 4.24 | | | |
| 6 | ∞ | 20.57 | 1.49700 | 81.5 | 4.15 | |
| 7 | ∞ | 0.50 | 5.28 | | | |
| 8 | ∞ | 0.20 | 1.51633 | 64.1 | 5.44 | |
| 9 | ∞ | 0.50 | 5.48 | | | |
| Image Plane | ∞ | | | | | |

Aspherical Data

| | | |
|---|---|---|
| 2nd Surface | | |
| K = 0.00000e+00 | A4 = 5.01156e−04 | A6 = 3.59925e−05 |
| A8 = 1.88479e−08 | A10 = 1.82967e−07 | |
| 3rd Surface | | |
| K = 0.00000e+00 | A4 = 2.98239e−03 | A6 = −1.33622e−04 |
| A8 = 9.16548e−06 | A10 = −3.48491e−07 | |
| 4th Surface | | |
| K = 0.00000e+00 | A4 = −1.85961e−03 | A6 = 3.21045e−05 |
| A8 = −5.32861e−06 | A10 = −6.08416e−07 | |
| 5th Surface | | |
| K = 0.00000e+00 | A4 = −9.44678e−03 | A6 = 1.65370e−04 |
| A8 = −1.50601e−04 | A10 = 1.83242e−05 | A12 = −2.88805e−06 |

| | |
|---|---|
| Focal Length | 23.00 |
| F-number | 3.60 |
| Half Field Angle | 6.97 |
| Image Height | 2.82 |
| BF | 0.50 |

Single Lens Data

| Lens | Start Surface | Focal Length |
|---|---|---|
| G1 | 1 | 10.50 |
| G2 | 4 | −12.24 |
| PR | 6 | INF |
| CG | 8 | INF |

[Tenth Numerical Example]
Unit: mm
Surface Data

| Surface | | | | | Effective | |
|---|---|---|---|---|---|---|
| Number | r | d | nd | νd | Diameter | θ gF |
| 1 (aperture) | ∞ | −0.50 | 6.50 | | | |
| 2 | 7.390 | 2.27 | 1.43875 | 94.7 | 6.50 | 0.5340 |
| 3* | −17.388 | 0.10 | 6.12 | | | |
| 4* | 6.794 | 2.00 | 1.56650 | 37.6 | 5.67 | |
| 5* | 3.330 | 2.03 | 4.38 | | | |
| 6 | ∞ | 22.11 | 1.52841 | 76.5 | 4.04 | |
| 7 | ∞ | 0.50 | 5.43 | | | |
| 8 | ∞ | 0.21 | 1.51633 | 64.1 | 5.50 | |
| 9 | ∞ | 1.00 | 5.52 | | | |
| Image Plane | ∞ | | | | | |

Aspherical Data

| | | |
|---|---|---|
| 3rd Surface | | |
| K = 1.79146e+01 | A4 = 1.13105e−03 | A6 = 1.23619e−05 |
| A8 = 1.51679e−06 | A10 = −2.61051e−07 | A12 = 1.74684e−08 |
| 4th Surface | | |
| K = −1.26612e−02 | A4 = −1.32255e−03 | A6 = −1.19584e−05 |
| A8 = 1.09459e−05 | A10 = −1.40756e−06 | A12 = 6.00271e−08 |
| 5th Surface | | |
| K = −1.00587e+00 | A4 = −1.04720e−03 | A6 = −6.72013e−05 |
| A8 = 5.92674e−05 | A10 = −1.03070e−05 | A12 = 6.83444e−07 |

| | |
|---|---|
| Focal Length | 26.00 |
| F-number | 4.00 |
| Half Field Angle | 6.18 |
| Image Height | 2.82 |
| BF | 1.00 |

Single Lens Data

| Lens | Start Surface | Focal Length |
|---|---|---|
| G1 | 1 | 12.16 |
| G2 | 4 | −14.57 |
| PR | 6 | INF |
| CG | 8 | INF |

[Eleventh Numerical Example]
Unit: mm
Surface Data

| Surface | | | | | Effective | |
|---|---|---|---|---|---|---|
| Number | r | d | nd | νd | Diameter | θ gF |
| 1 | ∞ | −0.60 | 7.00 | | | |
| (aperture) | | | | | | |
| 2 | 6.087 | 1.90 | 1.43875 | 94.7 | 7.00 | 0.5340 |
| 3 | 728.428 | 0.10 | 6.67 | | | |
| 4* | 27.587 | 0.90 | 1.53160 | 55.8 | 6.46 | |
| 5* | 8.305 | 0.95 | 5.78 | | | |
| 6 | ∞ | 28.36 | 1.51633 | 64.1 | 5.71 | |
| 7 | ∞ | 0.30 | 4.84 | | | |
| 8 | ∞ | 712.208 | 1.11 | 1.77250 | 49.6 | 4.91 |
| 9 | −15.564 | 1.23 | 5.03 | | | |
| 10* | −7.420 | 0.90 | 1.68040 | 18.1 | 5.00 | |
| 11* | −25.000 | 1.50 | 5.31 | | | |
| 12 | ∞ | 0.21 | 1.51633 | 64.1 | 5.60 | |
| 13 | ∞ | 0.10 | 5.63 | | | |
| Image | ∞ | | | | | |
| Plane | | | | | | |

Aspherical Data

| | | |
|---|---|---|
| 4th Surface | | |
| K = 0.00000e+00 | A4 = 1.12353e−03 | A6 = −4.72651e−05 |
| A8 = 1.12414e−06 | A10 = 9.66649e−09 | A12 = −1.45372e−09 |
| 5th Surface | | |
| K = 0.00000e+00 | A4 = 1.89926e−03 | A6 = −2.22889e−05 |
| A8 = 6.43929e−07 | A10 = 1.46870e−07 | A12 = −5.68504e−09 |
| 10th Surface | | |
| K = 0.00000e+00 | A4 = −1.92793e−03 | A6 = 1.41560e−03 |
| A8 = −4.29194e−04 | A10 = 6.04869e−05 | A12 = −3.26465e−06 |
| 11th Surface | | |
| K = 0.00000e+00 | A4 = −2.55182e−03 | A6 = 1.16588e−03 |
| A8 = −3.42437e−04 | A10 = 4.37563e−05 | A12 = −2.09926e−06 |

| | |
|---|---|
| Focal Length | 28.00 |
| F-number | 4.00 |
| Half Field Angle | 5.87 |
| Image Height | 2.82 |
| BF | 0.10 |

Single Lens Data

| Lens | Start Surface | Focal Length |
|---|---|---|
| G1 | 1 | 13.98 |
| G2 | 4 | −22.72 |
| PR | 6 | INF |
| G3 | 8 | 19.73 |
| G4 | 10 | −15.84 |
| CG | 12 | INF |

[Twelfth Numerical Example]
Unit: mm
Surface Data

| Surface | | | | | Effective | |
|---|---|---|---|---|---|---|
| Number | r | d | nd | νd | Diameter | θ gF |
| 1 (aperture) | ∞ | −0.50 | 5.17 | | | |
| 2* | 4.219 | 2.09 | 1.43875 | 94.7 | 5.17 | 0.5340 |
| 3* | −48.402 | 0.15 | 4.66 | | | |
| 4* | 6.292 | 2.00 | 1.61550 | 25.8 | 4.30 | |
| 5* | 3.003 | 0.77 | 2.95 | | | |
| 6 | ∞ | 8.66 | 1.71300 | 53.9 | 2.81 | |
| 7 | ∞ | 0.85 | 4.05 | | | |
| 8 | −3.945 | 0.90 | 1.60300 | 65.4 | 4.18 | |
| 9 | −4.021 | 0.85 | 4.75 | | | |
| 10 | ∞ | 0.21 | 1.51633 | 64.1 | 5.46 | |
| 11 | ∞ | 0.29 | 5.52 | | | |
| Image Plane | ∞ | | | | | |

Aspherical Data

| | | |
|---|---|---|
| 2nd Surface | | |
| K = 0.00000e+00 | A4 = −3.68452e−04 | A6 = −1.10266e−05 |
| 3rd Surface | | |
| K = 0.00000e+00 | A4 = 1.43179e−03 | A6 = −1.33176e−04 |
| A8 = 7.59013e−06 | | |
| 4th Surface | | |
| K = 0.00000e+00 | A4 = 4.67906e−04 | A6 = −1.04317e−04 |
| 5th Surface | | |
| K = 0.00000e+00 | A4 = 1.20522e−03 | A6 = 3.59103e−05 |
| A8 = 7.25389e−05 | | |

| | |
|---|---|
| Focal Length | 15.00 |
| F-number | 2.90 |
| Half Field Angle | 10.65 |
| Image Height | 2.82 |
| BF | 0.29 |

Single Lens Data

| Lens | Start Surface | Focal Length |
|---|---|---|
| G1 | 1 | 8.95 |
| G2 | 4 | −12.15 |
| PR | 6 | INF |
| G3 | 8 | 100.01 |
| CG | 10 | INF |

Table 1 presents the numerical values of physical quantities described above, and Table 2 presents the numerical values of the conditional expressions, according to the embodiments.

TABLE 1

| | First | Second | Third | Fourth | Fifth |
|---|---|---|---|---|---|
| | Embodiment | Embodiment | Embodiment | Embodiment | Embodiment |
| Nd_G1 | 1.4388 | 1.4970 | 1.4388 | 1.5284 | 1.4388 |
| νd_G1 | 94.66 | 81.54 | 94.66 | 76.46 | 94.66 |
| f | 17.00 | 14.00 | 14.00 | 15.00 | 16.00 |
| f_G1 | 9.85 | 8.06 | 8.84 | 6.34 | 9.26 |
| f_G2 | −11.91 | −10.57 | −12.49 | −6.76 | −12.19 |
| G1R1 | 5.8701 | 4.2514 | 4.7230 | 4.0853 | 5.4600 |
| G1R2 | −14.7851 | −54.7913 | −18.5084 | −15.3430 | −13.9288 |
| G2R1 | 4.8309 | 3.0333 | 3.4334 | 9.1478 | 4.2271 |
| G2R2 | 2.4738 | 1.8766 | 2.0897 | 2.5655 | 2.3524 |
| t_G1 | 1.8542 | 2.7532 | 2.2983 | 2.0496 | 2.1863 |
| θgF_G1 | 0.5340 | 0.5375 | 0.5340 | 0.5396 | 0.5340 |
| νd_G2 | 23.50 | 23.90 | 20.40 | 37.60 | 25.80 |
| LD | 5.000 | 4.400 | 4.396 | 5.130 | 5.000 |
| TTL | 20.181247 | 17.4 | 17.4381275 | 17.462486 | 19.3163605 |
| ω | 9.320 | 11.300 | 11.300 | 10.500 | 9.910 |
| EA_OBJ | 6.070 | 5.000 | 5.000 | 4.690 | 5.710 |
| EA_IMG | 3.580 | 2.990 | 3.040 | 2.890 | 3.530 |
| | Sixth | Seventh | Eighth | Ninth | Tenth |
| | Embodiment | Embodiment | Embodiment | Embodiment | Embodiment |
| Nd_G1 | 1.4388 | 1.4388 | 1.4388 | 1.4388 | 1.4388 |
| νd_G1 | 94.66 | 94.66 | 94.66 | 94.93 | 94.66 |
| f | 19.00 | 20.00 | 20.00 | 23.00 | 26.00 |
| f_G1 | 9.89 | 11.37 | 9.60 | 10.50 | 12.16 |
| f_G2 | −9.88 | −14.28 | −22.09 | −12.24 | −14.57 |
| G1R1 | 6.3113 | 6.5323 | 7.5905 | 6.3579 | 7.3900 |
| G1R2 | −12.3983 | −18.8259 | −8.7231 | −15.1983 | −17.3885 |
| G2R1 | 5.9505 | 5.3187 | −10.0652 | 5.5070 | 6.7938 |
| G2R2 | 2.5341 | 2.8390 | −73.1303 | 2.7239 | 3.3299 |
| t_G1 | 2.2459 | 2.2973 | 1.9410 | 1.9006 | 2.2667 |
| θgF_G1 | 0.5340 | 0.5340 | 0.5340 | 0.5340 | 0.5340 |
| νd_G2 | 37.60 | 25.80 | 55.84 | 37.60 | 37.60 |
| LD | 5.400 | 6.400 | 4.400 | 4.800 | 6.400 |
| TTL | 22.5711951 | 24.0492458 | 23.1101034 | 26.5679918 | 30.2200575 |
| ω | 8.390 | 7.970 | 8.000 | 6.970 | 6.180 |
| EA_OBJ | 6.330 | 6.670 | 6.250 | 6.390 | 6.500 |
| EA_IMG | 3.830 | 4.080 | 4.440 | 4.240 | 4.380 |

TABLE 2

| | First | Second | Third | Fourth | Fifth |
|---|---|---|---|---|---|
| | Embodiment | Embodiment | Embodiment | Embodiment | Embodiment |
| Conditional | 1.4388 | 1.4970 | 1.4388 | 1.5284 | 1.4388 |
| Expression (1) | | | | | |
| Conditional | 94.6600 | 81.5400 | 94.6600 | 76.4600 | 94.6600 |
| Expression (2) | | | | | |
| Conditional | 0.8269 | 0.7625 | 0.7083 | 0.9379 | 0.7598 |
| Expression (3) | | | | | |
| Conditional | 0.7004 | 0.7553 | 0.8918 | 0.4504 | 0.7616 |
| Expression (4) | | | | | |
| Conditional | 0.5792 | 0.5759 | 0.6316 | 0.4224 | 0.5786 |
| Expression (5) | | | | | |
| Conditional | 0.1091 | 0.1967 | 0.1642 | 0.1366 | 0.1366 |
| Expression (6) | | | | | |
| Conditional | −0.4316 | −0.8560 | −0.5934 | −0.5794 | −0.4368 |
| Expression (7) | | | | | |
| Conditional | 3.0990 | 4.2445 | 4.1106 | 1.7795 | 3.5096 |
| Expression (8) | | | | | |
| Conditional | 0.0494 | 0.0309 | 0.0494 | 0.0244 | 0.0494 |
| Expression (9) | | | | | |
| Conditional | 4.0281 | 3.4117 | 4.6402 | 2.0335 | 3.6690 |
| Expression (10) | | | | | |
| Conditional | 0.2941 | 0.3143 | 0.3140 | 0.3420 | 0.3125 |
| Expression (11) | | | | | |
| Conditional | 1.1871 | 1.2429 | 1.2456 | 1.1642 | 1.2073 |
| Expression (12) | | | | | |
| Conditional | 0.0025 | 0.0024 | 0.0027 | 0.0019 | 0.0020 |
| Expression (13) | | | | | |
| Conditional | 9.320 | 11.300 | 11.300 | 10.500 | 9.910 |
| Expression (14) | | | | | |
| Conditional | 0.590 | 0.598 | 0.608 | 0.616 | 0.618 |
| Expression (15) | | | | | |
| Conditional | 0.508 | 0.546 | 0.497 | 0.810 | 0.540 |
| Expression (16) | | | | | |
| | Sixth | Seventh | Eighth | Ninth | Tenth |
| | Embodiment | Embodiment | Embodiment | Embodiment | Embodiment |
| Conditional | 1.4388 | 1.4388 | 1.4388 | 1.4388 | 1.4388 |
| Expression (1) | | | | | |
| Conditional | 94.6600 | 94.6600 | 94.6600 | 94.9300 | 94.6600 |
| Expression (2) | | | | | |
| Conditional | 1.0011 | 0.7959 | 0.4346 | 0.8576 | 0.8345 |
| Expression (3) | | | | | |
| Conditional | 0.5202 | 0.7141 | 1.1045 | 0.5323 | 0.5604 |
| Expression (4) | | | | | |
| Conditional | 0.5208 | 0.5684 | 0.4799 | 0.4565 | 0.4677 |
| Expression (5) | | | | | |
| Conditional | 0.1182 | 0.1149 | 0.0971 | 0.0826 | 0.0872 |
| Expression (6) | | | | | |
| Conditional | −0.3253 | −0.4848 | −0.0694 | −0.4101 | −0.4035 |
| Expression (7) | | | | | |
| Conditional | 2.4835 | 3.2898 | −1.3192 | 2.9574 | 2.9226 |
| Expression (8) | | | | | |
| Conditional | 0.0494 | 0.0494 | 0.0494 | 0.0499 | 0.0494 |
| Expression (9) | | | | | |
| Conditional | 2.5176 | 3.6690 | 1.6952 | 2.5247 | 2.5176 |
| Expression | | | | | |
| (10) | | | | | |
| Conditional | 0.2842 | 0.3200 | 0.2200 | 0.2087 | 0.2462 |
| Expression | | | | | |
| (11) | | | | | |
| Conditional | 1.1880 | 1.2025 | 1.1555 | 1.1551 | 1.1623 |
| Expression | | | | | |
| (12) | | | | | |
| Conditional | 0.0016 | 0.0018 | 0.0003 | 0.0012 | 0.0010 |
| Expression | | | | | |
| (13) | | | | | |
| Conditional | 8.390 | 7.970 | 8.000 | 6.970 | 6.180 |
| Expression | | | | | |
| (14) | | | | | |
| Conditional | 0.605 | 0.612 | 0.710 | 0.664 | 0.674 |
| Expression | | | | | |
| (15) | | | | | |
| Conditional | 0.546 | 0.563 | 0.458 | 0.457 | 0.526 |
| Expression | | | | | |
| (16) | | | | | |

### [Folded Optical Element]

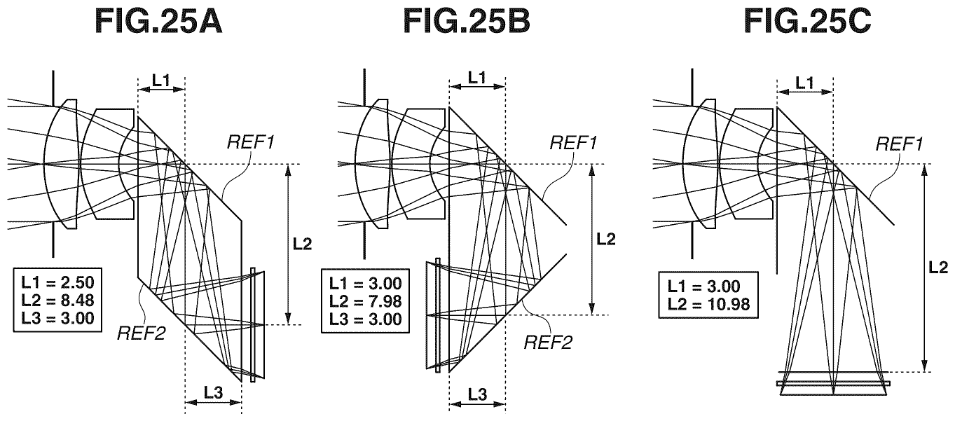

Next, the folded optical element PR according to each embodiment will be described in detail with reference to FIGS. 25A, 25B, and 25C. FIGS. 25A, 25B, and 25C each illustrate an example of a configuration of the folded optical element PR in the optical system L0 according to the first embodiment.

In FIG. 25A, the ray is bent (refracted) inside the folded optical element PR by two surfaces, namely, a surface REF1 and a surface REF2. The bending angle is 45° for both of the surfaces. The numerical values of a distance L1 from the object-side surface of the folded optical element PR to the surface REF1, a distance L2 from the surface REF1 to the surface REF2, and a distance L3 from the surface REF2 to the image-side surface of the folded optical element PR are indicated in FIG. 25A.

In FIG. 25B, the ray is bent inside the folded optical element PR by two surfaces, namely, the surface REF1 and the surface REF2. The bending angle is 45° for both of the surfaces. The numerical values of the distance L1 from the object-side surface of the folded optical element PR to the surface REF1, the distance L2 from the surface REF1 to the surface REF2, and the distance L3 from the surface REF2 to the image-side surface of the folded optical element PR are indicated in FIG. 25B.

In FIG. 25C, the ray is bent inside the folded optical element PR by the surface REF1.

The bending angle is 45°. The numerical values of the distance L1 from the object-side surface of the folded optical element PR to the surface REF1, and the distance L2 from the surface REF1 to the surface on the image plane side of the folded optical element PR are indicated in FIG. 25C.

Thus, regardless of the angle or the number of times the ray is bent inside the folded optical element PR, as long as a total optical axis distance inside the folded optical element PR is the same, aberration diagrams obtained are also identical, and therefore the image capturing optical systems can be regarded as identical.

As an example of the folded optical element PR, a prism is used in the present embodiment. However, a mirror may be used instead of the prism. In the prism and the mirror, the reflection angle may be 30°, 60°, or any other angle instead of 45°. Furthermore, the reflecting surface of the prism or the mirror may have a curved surface or an aspherical surface.

### [Image Capturing Apparatus]

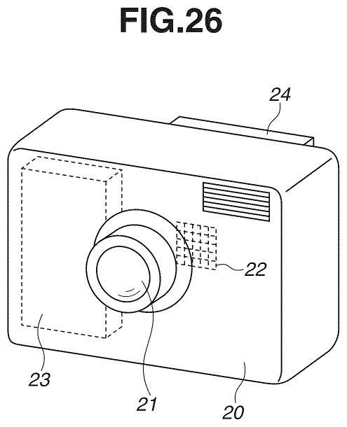

Next, an embodiment of an image capturing apparatus in which the optical system L0 according to each of the embodiments is used as an image capturing optical system will be described with reference to FIG. 26. A camera body 20 illustrated in FIG. 26 includes an image capturing optical system 21 similar to any one of the optical systems L0 according to the first to twelfth embodiments, and a solid-state image sensor (photoelectric conversion element) 22 that is incorporated in the camera body 20 and receives an object image formed by the image capturing optical system 21. The solid-state image sensor 22 is, for example, a CCD sensor or a CMOS sensor. A memory 23 is a recording unit that records the object image received by the image sensor 22. A finder 24 is a finder for observing the object image that is formed on the image sensor 22 and is displayed on a display element (not illustrated).

The camera body 20 may be a single-lens reflex camera including a quick return mirror or a mirrorless camera including no quick return mirror, or may be incorporated in a mobile terminal such as a smartphone.

The above-described solid-state image sensor 22 may be perpendicular to incident light, or may be inclined with respect to incident light. In this case, an inclination angle of the solid-state image sensor 22 with respect to the incident light and an inclination angle of the reflecting surface of the folded optical element PR can each be appropriately set depending on the configuration of the optical system L0 or the image capturing apparatus.

In this way, by applying the optical system L0 according to each of the embodiments to an image capturing apparatus such as a digital still camera, it is possible to obtain an image capturing optical system having small size and light weight while providing high optical performance, and an image capturing apparatus including the image capturing optical system.

While embodiments and examples of the disclosure have been described above, the disclosure is not limited to these embodiments and examples, and various combinations, modifications, and changes can be made within the scope of the disclosure.

In the optical system L0 according to each of the embodiments, the first lens G1 and the second lens G2 may be joined together to form a single cemented lens. With this configuration, an eccentric error or the like occurring in the first lens G1 and the second lens G2 can be suppressed, which leads to an improvement in optical performance of the optical system L0.

In the optical system L0 according to each of the embodiments, all or some of the lenses included in the optical system L0 may be used as a vibration-compensating lens group, and an imaging plane may be moved in a direction parallel to the optical axis to provide an image-stabilization function.

In the optical system L0 according to each of the embodiments, all or some of the lenses included in the optical system L0 may be used as lenses for focusing. Further, the optical system L0 may include not only a refractive optical element and a reflective optical element but also a diffractive optical element.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-016870, filed Feb. 4, 2025, which is hereby incorporated by reference herein in its entirety.

What is claimed is:

1. An optical system comprising, in order from an object side to an image side:
a first lens having positive refractive power;
a second lens having negative refractive power disposed adjacent to the first lens on an image side; and
a folded optical element disposed adjacent to the second lens on the image side,
wherein the following inequalities are satisfied:
$$1.3 < NdG 1 < 1.6 ; and$$
$$73. < vdG 1 < 120. ,$$
where NdG1 represents a refractive index of a material of the first lens for a d-line, and νdG1 represents an Abbe number of the material of the first lens for the d-line.

2. The optical system according to claim 1, wherein the following inequality is satisfied:
$$0.2 < \vert fG 1 / fG 2 \vert < 1.2 ,$$
where fG1 represents a focal length of the first lens, and fG2 represents a focal length of the second lens.

3. The optical system according to claim 1, wherein the following inequality is satisfied:
$$0. 20 < \vert fG 2 / f \vert < 2. ,$$
where fG2 represents a focal length of the second lens, and f represents a focal length of the entire optical system.

4. The optical system according to claim 1, wherein the first lens has an aspherical shape.

5. The optical system according to claim 4, wherein the aspherical shape of the first lens is an aspherical shape in which positive refractive power becomes weaker toward periphery from an optical axis center.

6. The optical system according to claim 1, wherein the following inequality is satisfied:
$$0.2 < fG 1 / f < 1. ,$$
where fG1 represents a focal length of the first lens, and f represents a focal length of the entire optical system.

7. The optical system according to claim 1, wherein the following inequality is satisfied:
$$0.01 < tG 1 / f < 0.35 ,$$
where tG1 represents thickness in an optical axis direction at an optical axis center of the first lens, and f represents a focal length of the entire optical system.

8. The optical system according to claim 1, wherein the following inequality is satisfied:
$$- 2. < ( G 1 R 1 + G 1 R 2 ) / ( G 1 R 1 - G 1 R 2 ) < 0.5 ,$$
where G1R1 represents a radius of curvature of an object-side lens surface of the first lens, and G1R2 represents a radius of curvature of an image-side lens surface of the first lens.

9. The optical system according to claim 1, wherein the following inequality is satisfied:
$$- 3. < ( G 2 R 1 + G 2 R 2 ) / ( G 2 R 1 - G 2 R 2 ) < 7. ,$$
where G2R1 represents a radius of curvature of an object-side lens surface of the second lens, and G2R2 represents a radius of curvature of an image-side lens surface of the second lens.

10. The optical system according to claim 1, wherein the following inequality is satisfied:
$$0.005 < θ gFG 1 - 0.6438 + 0.001682 \times vdG 1 < 0.1 ,$$
where θgFG1 represents a partial dispersion ratio of the material of the first lens.

11. The optical system according to claim 1, wherein the following inequality is satisfied:
$$1. < vdG 1 / vdG 2 < 8. ,$$
where νdG2 represents an Abbe number of a material of the second lens for a d-line.

12. The optical system according to claim 1, wherein the following inequality is satisfied:
$$0.1 < LD / f < 0.6 ,$$
where LD represents a distance on an optical axis from an object-side lens surface of the first lens to an object-side surface of the folded optical element, and f represents a focal length of the entire optical system.

13. The optical system according to claim 1, wherein the following inequality is satisfied:
$$0.4 < TTL / f < 4. ,$$
where TTL represents a total optical length of the optical system, and f represents a focal length of the entire optical system.

14. The optical system according to claim 1, wherein the following inequality is satisfied:
$$\vert 1 / ( fG 1 \times vdG 1 ) + 1 / ( fG 2 \times vdG 2 ) \vert < 0.005 ,$$
where fG1 represents a focal length of the first lens, fG2 represents a focal length of the second lens, and νdG2 represents an Abbe number of a material of the second lens for a d-line.

15. The optical system according to claim 1, wherein the following inequality is satisfied:
$$4 < ω < 20 ,$$
where ω [°] represents an imaging half field angle of the optical system.

16. The optical system according to claim 1, wherein the following inequality is satisfied:
$$0.1 < EA\_IMG / EA\_OBJ < 1. ,$$
where EA_OBJ represents an effective aperture diameter of an object-side lens surface of a lens disposed closest to the object side in the optical system, and EA_IMG represents an effective aperture diameter of an image-side lens surface of a lens disposed closest to the image side in the optical system.

17. The optical system according to claim 1, wherein the following inequality is satisfied:
$$0.2 < LD / fG 1 < 1. ,$$
where LD represents a distance on an optical axis from an object-side lens surface of the first lens to an object-side surface of the folded optical element, and fG1 represents a focal length of the first lens.

18. The optical system according to claim 1, wherein the second lens has an aspherical shape.

19. The optical system according to claim 18, wherein the aspherical shape of the second lens is an aspherical shape in which negative refractive power becomes stronger toward periphery from an optical axis center.

20. The optical system according to claim 1, wherein the folded optical element reflects an incident ray multiple times inside the folded optical element.

21. The optical system according to claim 1, wherein the first lens, the second lens, and the folded optical element, disposed in order from the object side to the image side, constitute the optical system.

22. The optical system according to claim 1, further comprising a third lens having positive refractive power,
wherein the first lens, the second lens, the folded optical element, and the third lens are disposed in order from the object side to the image side.

23. The optical system according to claim 1, further comprising a third lens having negative refractive power,
wherein the first lens, the second lens, the folded optical element, and the third lens are disposed in order from the object side to the image side.

24. The optical system according to claim 1, further comprising:
a third lens having positive refractive power; and
a fourth lens having negative refractive power,
wherein the first lens, the second lens, the folded optical element, the third lens, and the fourth lens are disposed in order from the object side to the image side.

25. An image capturing apparatus comprising:
an optical system; and
an image sensor configured to receive an image formed by the optical system,
wherein the optical system includes, in order from an object side to an image side:
a first lens having positive refractive power;
a second lens having negative refractive power disposed adjacent to the first lens on an image side; and
a folded optical element disposed adjacent to the second lens on the image side, and
wherein the following inequalities are satisfied:
$$\begin{matrix}1.3 < NdG 1 < 1.6 ; and \\ 73. < vdG 1 < 120. ,\end{matrix}$$
where NdG1 represents a refractive index of a material of the first lens for a d-line, and νdG1 represents an Abbe number of the material of the first lens for the d-line.
